(19) United States
(12) Patent Application Publication
(10) Pub. No.: US 2026/0249173 A1
(43) Pub. Date: Aug. 27, 2026

(54) ONE OR MORE NON-TRANSITORY COMPUTER-READABLE STORAGE MEDIA, COMPUTER-IMPLEMENTED METHOD, AND INFORMATION PROCESSING SYSTEM

(71) Applicant: Nintendo Co., Ltd., Kyoto (JP)

(72) Inventor: Rei MIYAKE, Kyoto (JP)

(21) Appl. No.: 19/534,139

(22) Filed: Feb. 9, 2026

(30) Foreign Application Priority Data
Feb. 21, 2025 (JP) 2025-026713

(51) Int. Cl. A63F 13/285; G06F 3/01

(52) U.S. Cl. CPC A63F 13/285; G06F 3/016

(57) ABSTRACT

An example of an information processing system according to an exemplary embodiment, based on first vibration waveform data stored in advance with a first resolution and a magnification parameter for compressing the amplitude of the first vibration waveform data, generates second waveform data that is waveform data obtained by compressing an amplitude of the first vibration waveform data and has a second resolution higher than the first resolution, and outputs the second waveform data. A vibration device is vibrated based on the output second waveform data.

### CROSS REFERENCE TO RELATED APPLICATION

This application claims priority to Japanese Patent Application No. 2025-026713 filed on February 21, 2025, the entire contents of which are incorporated herein by reference.

### FIELD

An exemplary embodiment relates to one or more non-transitory computer-readable storage media having stored therein an information processing program, a computer-implemented method, an information processing system, and an information processing apparatus for controlling a vibration device.

### BACKGROUND AND SUMMARY

Conventionally, there is a vibration control program for vibrating a vibration device.

It is assumed that a vibration signal is output based on a waveform with a high accuracy to a vibration device capable of vibrating in response to a waveform with a higher resolution.

An exemplary embodiment discloses one or more non-transitory computer-readable storage media having stored therein an information processing program, a computer-implemented method, an information processing system, and an information processing apparatus that are capable of outputting a vibration signal based on a waveform having a higher accuracy.

### First Configuration

A first configuration of the exemplary embodiment is one or more non-transitory computer-readable storage media having stored therein instructions that, when executed, cause one or more processors to perform operations including: based on first waveform data recorded with a first resolution used to vibrate a vibration device and a magnification parameter for compressing the amplitude of the first waveform data, generating second waveform data that is waveform data obtained by compressing an amplitude of the first waveform data and has a second resolution higher than the first resolution; and outputting the second waveform data.

Based on the above, it is possible to output a vibration signal having a waveform with a higher accuracy to a vibration device capable of vibrating in response to a waveform having a high resolution than in a case where waveform data recorded as a waveform having a small amplitude is used.

### Second Configuration

According to a second configuration, in the above first configuration, the magnification parameter may be recorded in response to a reproduction time of the first waveform data. The operations may further comprise generating the second waveform data in accordance with a lapse of time based on the first waveform data and the magnification parameter with respect to each reproduction time.

Based on the above, a magnification parameter is set in accordance with the reproduction time, whereby it is possible to change an amplitude without creating or editing waveform data.

### Third Configuration

According to a third configuration, in the above first or second configuration, pitch information for adjusting a pitch of the first waveform data may be further recorded in response to a reproduction time of the first waveform data. The operations may further comprise generating the second waveform data in accordance with a lapse of time based on waveform data obtained by changing the first waveform data based on the pitch information with respect to each reproduction time.

Based on the above, it is also possible to change not only an amplitude but also a pitch.

### Fourth Configuration

According to a fourth configuration, in any of the above first to third configurations, reproduction speed information may be further recorded in response to a reproduction time of the first waveform data. The operations may further comprise generating the second waveform data in accordance with a lapse of time by changing a reproduction portion of the first waveform data based on the reproduction speed information with respect to each reproduction time.

Based on the above, it is possible to change not only the amplitude but also the reproduction speed of first waveform data.

Another configuration may be a computer-implemented method for controlling a vibration of a vibration device, or may be an information processing system, or may be an information processing apparatus.

According to an example of the exemplary embodiment, it is possible to output a vibration signal having a waveform with a high accuracy with respect to a vibration device capable of vibrating in response to a waveform having a high resolution.

These and other features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is an example non-limiting diagram showing an example of a game system;

FIG. 2 is an example non-limiting block diagram showing an example of the internal configuration of a main body apparatus;

FIG. 3 is an example non-limiting block diagram showing examples of the internal configurations of a main body apparatus 2, a left controller 3, and a right controller 4;

FIG. 4 is an example non-limiting diagram showing an example of first vibration waveform data stored in advance;

FIG. 5 is an example non-limiting diagram showing an example of waveform data obtained by compressing the amplitude of the first vibration waveform data shown in FIG. 4 based on a magnification parameter;

FIG. 6 is an example non-limiting diagram showing an example of second vibration waveform data stored in advance;

FIG. 7 is an example non-limiting diagram showing an example of a magnification parameter that decreases in a stepwise manner in accordance with the reproduction time;

FIG. 8 is an example non-limiting diagram showing an example of waveform data when the second vibration waveform data shown in FIG. 6 is loop-reproduced and the magnification parameter that changes in accordance with the reproduction time and is shown in FIG. 7 is applied;

FIG. 9 is an example non-limiting diagram showing another example of the magnification parameter that changes in accordance with the reproduction time;

FIG. 10 is an example non-limiting diagram showing examples of various pieces of data stored in a game system 1; and

FIG. 11 is an example non-limiting flow chart showing an example of a vibration control process.

### DETAILED DESCRIPTION OF NON-LIMITING EXAMPLE EMBODIMENTS

### Game System Configuration

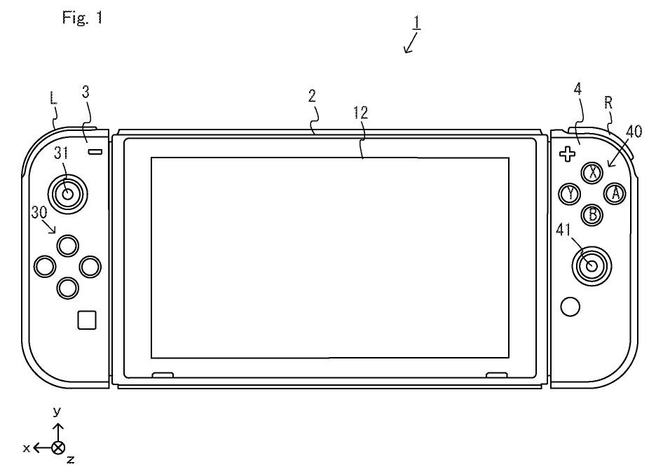

A game system according to an example of an exemplary embodiment is described below. FIG. 1 is a diagram showing an exemplary game system. An example of a game system 1 according to the exemplary embodiment includes a main body apparatus (an information processing apparatus; which functions as a game apparatus main body in the exemplary embodiment) 2, a left controller 3, and a right controller 4. The main body apparatus 2 is an apparatus for performing various processes (e.g., game processing) in the game system 1. The left controller 3 and the right controller 4 each include a plurality of direction buttons 30 including an up button, a down button, a right button, and a left button, a plurality of buttons 40 (an A-button, a B-button, an X-button, a Y-button, an L-button, an R-button, and the like), a left analog stick 31, and a right analog stick 41 as exemplary operation units through which a user performs input.

Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2, or the main body apparatus 2, the left controller 3, and the right controller 4 may be separated from one another, when being used. It should be noted that hereinafter, the left controller 3 and the right controller 4 will occasionally be referred to collectively as a "controller".

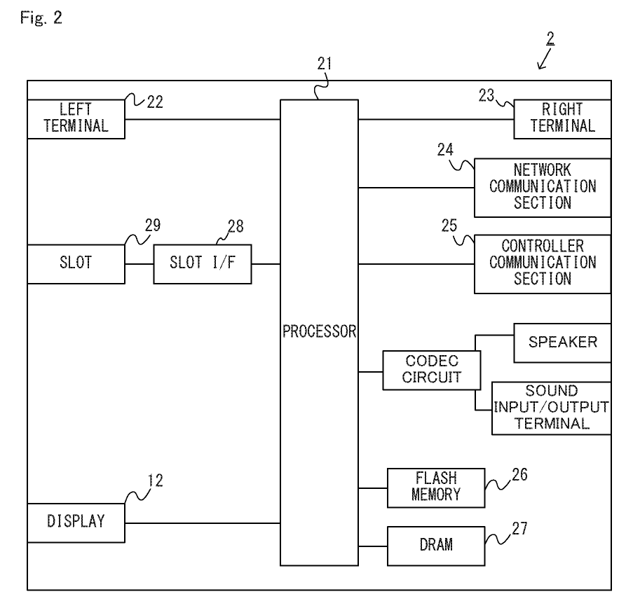

FIG. 2 is a block diagram showing an example of the internal configuration of the main body apparatus 2. As shown in FIG. 2, the main body apparatus 2 includes a processor 21. The processor 21 is an information processing section for executing various types of information processing (e.g., game processing) to be executed by the main body apparatus 2, and for example, includes one of more CPUs (Central Processing Units) and one of more GPUs (Graphics Processing Units). Note that the processor 21 may be configured only by a CPU, or may be configured by a SoC (System-on-a-Chip) that includes a plurality of functions such as a CPU function and a GPU function. The processor 21 executes an information processing program (e.g., a game program) stored in a storage section (specifically, an internal storage medium such as a flash memory 26, an external storage medium attached to the slot 29, or the like), thereby performing the various types of information processing.

Further, the main body apparatus 2 also includes a display 12. The display 12 displays an image generated by the main body apparatus 2. In the exemplary embodiment, the display 12 is a liquid crystal display device (LCD). The display 12, however, may be a display device of any type. The display 12 is connected to the processor 21. The processor 21 displays a generated image (e.g., an image generated by executing the above information processing) and/or an externally acquired image on the display 12.

Further, the main body apparatus 2 includes a left terminal 22, which is a terminal for the main body apparatus 2 to perform wired communication with the left controller 3, and a right terminal 23, which is a terminal for the main body apparatus 2 to perform wired communication with the right controller 4.

Further, the main body apparatus 2 includes a flash memory 26 and a DRAM (Dynamic Random Access Memory) 27 as examples of internal storage media built into the main body apparatus 2. The flash memory 26 and the DRAM 27 are connected to the processor 21. The flash memory 26 is a memory mainly used to store various data (or programs) to be saved in the main body apparatus 2. The DRAM 27 is a memory used to temporarily store various data used for information processing.

The main body apparatus 2 includes a slot 29. The slot 29 is so shaped as to allow a predetermined type of storage medium to be attached to the slot 29. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of a game application or the like) used by the main body apparatus 2 and/or a program (e.g., a game program or the like) executed by the main body apparatus 2.

The main body apparatus 2 includes a slot interface (hereinafter abbreviated as "I/F") 28. The slot I/F 28 is connected to the processor 21. The slot I/F 28 is connected to the slot 29, and in accordance with an instruction from the processor 21, reads and writes data from and to the predetermined type of storage medium (e.g., a dedicated memory card) attached to the slot 29.

The processor 21 appropriately reads and writes data from and to the flash memory 26, the DRAM 27, and each of the above storage media, thereby performing the above information processing.

The main body apparatus 2 includes a network communication section 24. The network communication section 24 is connected to the processor 21. The network communication section 24 performs wired or wireless communication with an external apparatus via a network. In the exemplary embodiment, as a first communication form, the network communication section 24 connects to a wireless LAN and communicates with an external apparatus, using a method compliant with the Wi-Fi (registered trademark) standard. Further, as a second communication form, the network communication section 24 wirelessly communicates with another main body apparatus 2 of the same type, using a predetermined communication method (e.g., communication based on a unique protocol or infrared light communication). It should be noted that the wireless communication in the above second communication form achieves the function of enabling so-called "local communication" in which the main body apparatus 2 can wirelessly communicate with another main body apparatus 2 placed in a closed local network area, and the plurality of main body apparatuses 2 communicate with each other directly or indirectly via an access point to transmit and receive data.

The main body apparatus 2 includes a controller communication section 25. The controller communication section 25 is connected to the processor 21. The controller communication section 25 wirelessly communicates with the left controller 3 and/or the right controller 4. The communication method between the main body apparatus 2 and the left controller 3 and the right controller 4 is optional. In the exemplary embodiment, the controller communication section 25 performs communication compliant with the Bluetooth (registered trademark) standard with the left controller 3 and with the right controller 4.

The processor 21 is connected to the left terminal 22 and the right terminal 23. When performing wired communication with the left controller 3, the processor 21 transmits data to the left controller 3 via the left terminal 22 and also receives operation data from the left controller 3 via the left terminal 22. Further, when performing wired communication with the right controller 4, the processor 21 transmits data to the right controller 4 via the right terminal 23 and also receives operation data from the right controller 4 via the right terminal 23. As described above, in the exemplary embodiment, the main body apparatus 2 can perform both wired communication and wireless communication with each of the left controller 3 and the right controller 4.

The main body apparatus 2 also includes a codec circuit, a speaker (specifically, a left speaker and a right speaker), and an audio input/output terminal. The codec circuit is connected to the speaker and the audio input/output terminal and also connected to the processor 21. The codec circuit is a circuit that controls the input and output of audio data to and from the speaker and the audio input/output terminal.

It should be noted that, in addition to the elements shown in FIG. 2, the main body apparatus 2 includes a battery that supplies power and an output terminal for outputting images and audio to an external display device (e.g., a television) separate from the display 12.

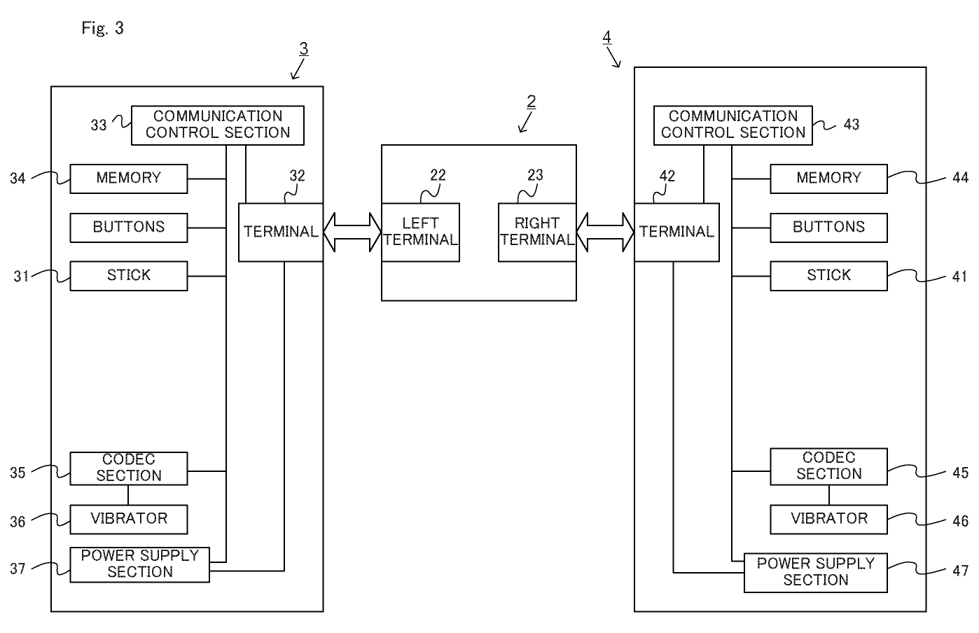

FIG. 3 is a block diagram showing examples of the internal configurations of the main body apparatus 2, the left controller 3, and the right controller 4. It should be noted that the details of the internal configuration of the main body apparatus 2 are shown in FIG. 2 and therefore are omitted in FIG. 3.

The left controller 3 includes a communication control section 33, which communicates with the main body apparatus 2. As shown in FIG. 3, the communication control section 33 is connected to components including a terminal 32. In the exemplary embodiment, the communication control section 33 can communicate with the main body apparatus 2 through both wired communication via the terminal 32 and wireless communication not via the terminal 32. The communication control section 33 controls the method for communication performed by the left controller 3 with the main body apparatus 2. That is, when the left controller 3 is attached to the main body apparatus 2, the communication control section 33 communicates with the main body apparatus 2 via the terminal 32. Further, when the left controller 3 is detached from the main body apparatus 2, the communication control section 33 wirelessly communicates with the main body apparatus 2 (specifically, the controller communication section 25). The wireless communication between the controller communication section 25 and the communication control section 33 is performed in accordance with the Bluetooth (registered trademark) standard, for example.

Further, the left controller 3 includes a memory 34 such as a flash memory. The communication control section 33 includes, for example, a microcomputer (or a microprocessor) and executes firmware stored in the memory 34, thereby performing various processes.

The left controller 3 includes buttons 103 (specifically, the buttons 30 , the L-button, and the like). Further, the left controller 3 includes the analog stick 31. Each of the buttons and the analog stick 31 outputs information regarding an operation performed on itself to the communication control section 33 repeatedly at appropriate timing.

The communication control section 33 acquires information regarding an input from each of input sections (specifically, the buttons, the analog stick 31, and the like). The communication control section 33 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 31 based on the operation data.

The left controller 3 includes a vibrator 36 for generating a vibration. In the exemplary embodiment, the vibrator 36 is controlled based on vibration data from the main body apparatus 2. That is, if the communication control section 33 receives the above vibration data from the main body apparatus 2, the communication control section 33 drives the vibrator 36 in accordance with the received command. Here, the left controller 3 includes a codec section 35. If the communication control section 33 receives the above vibration data, the communication control section 33 outputs a control signal corresponding to the vibration data to the codec section 35. The codec section 35 generates a driving signal for driving the vibrator 36 from the control signal from the communication control section 33 and gives the driving signal to the vibrator 36. Consequently, the vibrator 36 operates. The vibration data from the main body apparatus 2 may be transmitted to the controller at predetermined time intervals (e.g., 1/200-second intervals).

Specifically, the vibration data includes the frequency (the number of vibrations per unit time; also referred to as the "pitch") and the amplitude of a vibration. The vibrator 36 is configured to vibrate at the frequency and the amplitude specified based on the vibration data. For example, the vibrator 36 is a linear vibration motor driven in a predetermined direction. The vibrator 36 may be a linear vibration motor configured to vibrate at a first resonance frequency in a first direction and vibrate at a second resonance frequency lower than the first resonance frequency in a second direction. Such a vibrator 36 can vibrate in a first frequency band (a high-frequency band) including the first resonance frequency and also vibrate in a second frequency band (a low-frequency band) including the second resonance frequency.

Vibration data transmitted from the main body apparatus 2 includes first vibration data and second vibration data. The first vibration data includes the frequency and the amplitude in the high-frequency band. The second vibration data includes the frequency and the amplitude in the low-frequency band. The left controller 3 receives the vibration data including the first vibration data and the second vibration data from the main body apparatus 2. The left controller 3 controls the vibrator 36 based on the first vibration data and the second vibration data, whereby the vibrator 36 can vibrate at frequencies from the low-frequency band to the high-frequency band. The main body apparatus 2 transmits vibration data at predetermined time intervals (e.g., 1/200-second intervals) and changes the frequency and the amplitude included in each of the pieces of vibration data and thereby can vibrate the vibrator 36 in various vibration patterns. For example, based on vibration waveform data indicating the waveform of a vibration (data in which frequencies and amplitudes are arranged in chronological order), the main body apparatus 2 can vibrate the vibrator 36 based on the waveform according to the vibration waveform data.

The left controller 3 includes a power supply section 37. In the exemplary embodiment, the power supply section 37 includes a battery and a power control circuit. Although not shown in FIG. 3, the power control circuit is connected to the battery and also connected to components of the left controller 3 (specifically, components that receive power supplied from the battery).

As shown in FIG. 3, the right controller 4 includes a communication control section 43, which communicates with the main body apparatus 2. Further, the right controller 4 includes a memory 44, which is connected to the communication control section 43. The communication control section 43 is connected to components including a terminal 42. The communication control section 43 and the memory 44 have functions similar to those of the communication control section 33 and the memory 34, respectively, of the left controller 3.

Further, the right controller 4 includes a vibrator 46 and a codec section 45. The vibrator 46 and the codec section 45 operate similarly to the vibrator 36 and the codec section 35, respectively, of the left controller 3.

The right controller 4 includes a power supply section 47. The power supply section 47 has a function similar to that of the power supply section 37 of the left controller 3 and operates similarly to the power supply section 37.

### Overview of Vibration Control

Next, an overview of vibration control performed by the game system 1 is described. In the exemplary embodiment, for example, the left vibrator 36 and the right vibrator 46 are vibrated in accordance with the occurrence of a predetermined vibration event. For example, the vibration event is an event that occurs during the execution of a game. For example, the vibration event may be the state where a player object comes close to a virtual vibration source present in a virtual space. The vibration event may be the state where a predetermined object enters a particular state in the game.

The main body apparatus 2 (e.g., the flash memory 26 or a storage medium attached to the slot 29) stores a plurality of pieces of vibration waveform data in advance. Vibration waveform data is data indicating the waveform of a vibration and is data indicating in what vibration pattern the vibrator is to be vibrated. Specifically, the vibration waveform data is data in which frequencies and amplitudes at points in time are arranged in chronological order.

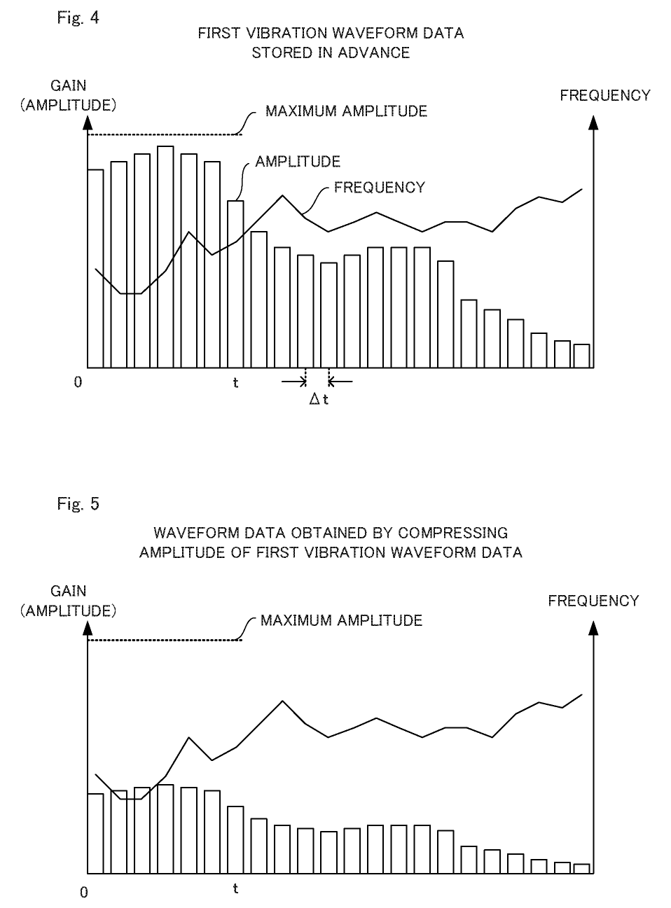

FIG. 4 is a diagram showing an example of first vibration waveform data stored in advance. In FIG. 4, the left vertical axis represents an amplitude (gain), the right vertical axis represents a frequency, and the horizontal axis represents time. In FIG. 4, a bar graph indicates the amplitude, and a line graph indicates the frequency. Vibration waveform data stores the amplitude and the frequency at each point in time, and the amplitude and the frequency change in accordance with the lapse of time. An interval Δt at each point in time is 1/200 seconds, for example.

Each of the amplitude and the frequency at each point in time of the vibration waveform data is represented by 8-bit data, for example. On the other hand, the left vibrator 36 and the right vibrator 46 are configured to vibrate at a specified amplitude and a specified frequency, and each of an amplitude and a frequency that can be input to the left vibrator 36 and the right vibrator 46 is represented by 10-bit data. When the main body apparatus 2 reproduces the vibration waveform data, the main body apparatus 2 transmits vibration data (left vibration data and right vibration data) obtained by converting the amplitude and the frequency represented in 8 bits to 10 bits to the left controller 3 and the right controller 4. The left controller 3 and the right controller 4 vibrate the left vibrator 36 and the right vibrator 46 based on the received left vibration data and right vibration data, respectively.

For example, the developer of the game creates first vibration waveform data as shown in FIG. 4 while finely adjusting the amplitude and the frequency at each point in time. The maximum value of the amplitude that can be specified in the vibrators 36 and 46 according to the exemplary embodiment is great, and if the vibrators 36 and 46 are vibrated by specifying an amplitude close to the maximum value, housings of the controllers 3 and 4 may vibrate by great amounts, and a sound audible by the user may be generated or a vibration that is too intense and causes a sense of discomfort to the user may be generated. This may result in a vibration unintended by the developer. To prevent such a situation, it is also possible that when the developer creates vibration waveform data, the developer creates a waveform having a small amplitude. In this case, however, it is necessary to adjust the amplitude in a narrow range. Thus, it is not possible to finely adjust the amplitude. Moreover, if data having a lower resolution is used for a vibrator that can be vibrated with waveform data having a higher resolution, detailed information may be lost.

Thus, in the exemplary embodiment, first vibration waveform data having a great amplitude is created in advance, and a magnification parameter to be applied to the first vibration waveform data is set. The magnification parameter is a coefficient used to multiply the amplitude of the first vibration waveform data and is a parameter for compressing (decrease) the amplitude overall. The first vibration waveform data and the magnification parameter are stored, and the magnification parameter is applied to the stored first vibration waveform data at runtime, thereby decreasing the amplitude.

Specifically, the main body apparatus 2 acquires the amplitude and the frequency from the first vibration waveform data based on a reproduction time t (the elapsed time from the start of the reproduction) of the first vibration waveform data. The main body apparatus 2 multiplies the acquired amplitude by a magnification indicated by the magnification parameter, thereby decreasing the amplitude. The main body apparatus 2 generates vibration data by converting each of the decreased amplitude and the acquired frequency to 10-bit data and transmits the generated vibration data to the controllers.

FIG. 5 is a diagram showing an example of waveform data obtained by compressing the amplitude of the first vibration waveform data shown in FIG. 4 based on the magnification parameter. As shown in FIG. 5, if the magnification parameter is applied to the first vibration waveform data, the amplitude of the first vibration waveform data is decreased overall. Even if the amplitude is decreased based on the magnification parameter, the pitch (the frequency) is not changed.

Each of the vibrators (36 and 46) according to the exemplary embodiment is configured so that each of the amplitude and the frequency of the vibrator is specified by 10-bit data. Thus, the vibrator can be vibrated based on a waveform having a high resolution. In a case where first waveform data having a wide range of the amplitude is created and recorded and the vibrators are vibrated using second waveform data obtained by compressing the amplitude of the first waveform data overall as in the exemplary embodiment, it is possible to vibrate the vibrators using waveform data with a higher accuracy than in a case where waveform data having a narrow range of the amplitude and a small amplitude is created. For example, also in a case where the first waveform data is created by assuming a vibrator having a first resolution, it is possible to output a vibration signal having a waveform with a high accuracy to a vibrator having a second resolution higher than the first resolution without creating waveform data again. Thus, it is possible to flexibly handle a vibrator compatible with various resolutions. The maximum value of the amplitude that can be specified in the vibrators according to the exemplary embodiment is great, and the vibrators are rarely vibrated by specifying an amplitude close to the maximum value. As described above, there is room for the compression of a vibrator capable of vibrating at an amplitude that is too intense and is rarely used, and the above method is effective.

As described above, when the vibration waveform data is created, the amplitude is set by making the maximum use of the dynamic range, and when the vibration waveform data is reproduced, the vibrators are controlled based on waveform data obtained by compressing the amplitude overall based on the magnification parameter, whereby it is possible to generate a vibration with a high accuracy as intended by the developer.

### Change over Time in Magnification Parameter

The above magnification parameter may be changed in accordance with the reproduction time of the vibration waveform data. For example, the vibration waveform data is loop-reproduced, and the magnification parameter is gradually decreased in accordance with the reproduction time, whereby it is possible to gradually decrease the amplitude.

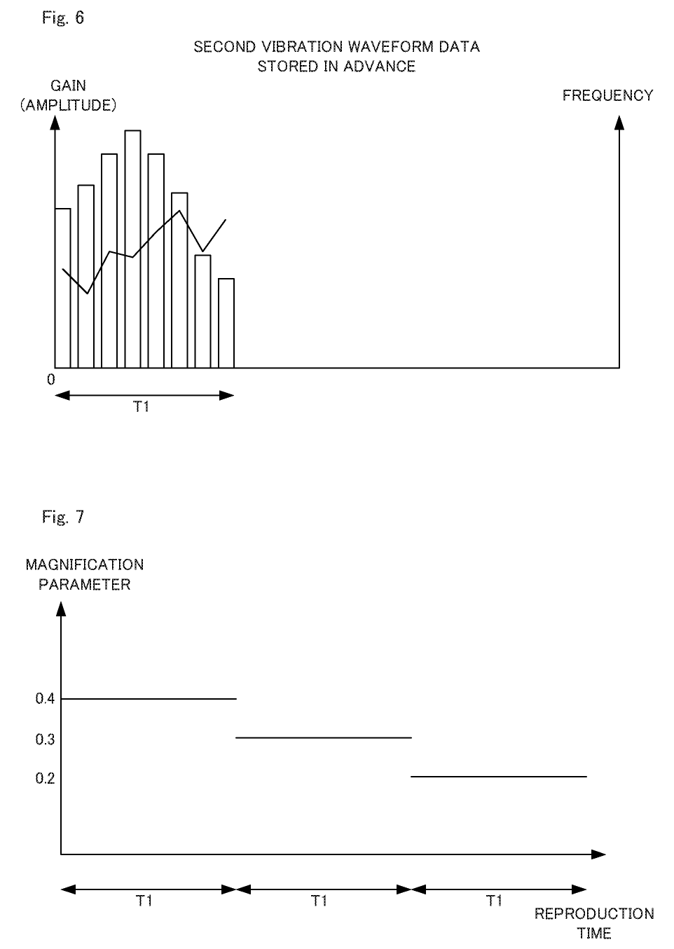

FIG. 6 is a diagram showing an example of second vibration waveform data stored in advance. FIG. 7 is a diagram showing an example of a magnification parameter that decreases in a stepwise manner in accordance with the reproduction time. FIG. 8 is a diagram showing an example of waveform data when the second vibration waveform data shown in FIG. 6 is loop-reproduced and the magnification parameter that changes in accordance with the reproduction time shown in FIG. 7 is applied.

As shown in FIG. 6, for example, second vibration waveform data is waveform data for generating a vibration having a length T1 in which the amplitude and the frequency change in accordance with the reproduction time. As shown in FIG. 7, a magnification parameter decreases in accordance with the reproduction time. For example, the magnification parameter may be a value that decreases every time the time T1 elapses from the start of the reproduction of the second vibration waveform data. While the second vibration waveform data is repeatedly reproduced, the magnification parameter that decreases in accordance with the reproduction time is applied, whereby, as shown in FIG. 8, it is possible to generate a vibration in which the intensity of the vibration weakens while the vibration repeats the same waveform.

In FIG. 8, the magnification parameter when an N+1-th loop reproduction is performed is set to be smaller than the magnification parameter when an N-th loop reproduction is performed (N is a positive integer), thereby generating a vibration in which the intensity of the vibration gradually weakens. In another form, the magnification parameter when the N+1-th loop reproduction is performed may be set to be greater than the magnification parameter when the N-th loop reproduction is performed, thereby generating a vibration in which the intensity of the vibration gradually strengthens.

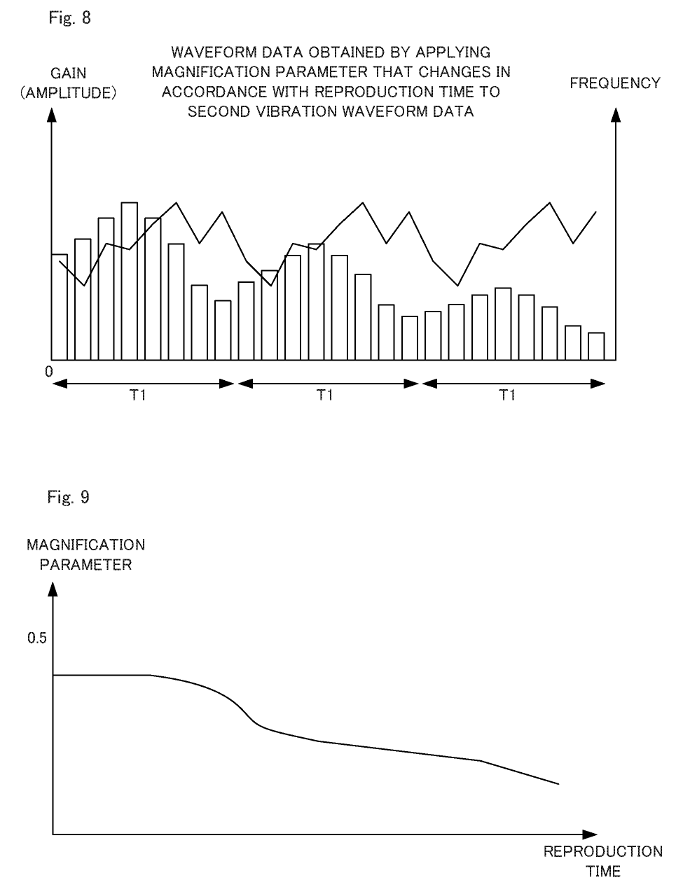

During a single reproduction of the vibration waveform data, the magnification parameter may be changed in accordance with the reproduction time. FIG. 9 is a diagram showing another example of the magnification parameter that changes in accordance with the reproduction time. As shown in FIG. 9, a magnification parameter that continuously changes in accordance with the reproduction time may be stored in advance. In accordance with the reproduction time, the amplitude of the vibration waveform data may be decreased based on the vibration waveform data and the magnification parameter.

### Changes in Pitch and Reproduction Speed

In the exemplary embodiment, not only the amplitude but also the pitch (the frequency) of a vibration can be changed based on pitch information. The pitch information is a parameter for changing the pitch of a vibration based on vibration waveform data. For example, the pitch information may be a parameter indicating the rate of an increase or a decrease in the frequency of the vibration waveform data. When the vibration waveform data stored in advance is reproduced, the frequency included in the vibration waveform data may be multiplied by the rate indicated by the pitch information, thereby changing the pitch. The pitch information may be a parameter indicating a value for increasing or decreasing the frequency of the vibration waveform data. The pitch information may be changed in accordance with the reproduction time. For example, the pitch information may change in a stepwise manner in accordance with the reproduction time, or may continuously change in accordance with the reproduction time.

In the exemplary embodiment, the reproduction speed of vibration waveform data can also be changed based on reproduction speed information. The reproduction speed information is a parameter for changing the reproduction speed of vibration waveform data stored in advance. For example, a reproduction portion of the vibration waveform data according to the elapsed time from the start of the reproduction is changed based on the reproduction speed information, whereby it is possible to make the reproduction speed of the vibration waveform data faster or slower than normal.

The reproduction speed information may be changed in accordance with the reproduction time. For example, the reproduction speed information may change in a stepwise manner in accordance with the reproduction time, or may continuously change in accordance with the reproduction time. For example, the vibration waveform data is loop-reproduced while the reproduction speed is made fast in accordance with the lapse of time, whereby it is possible to generate a vibration in which vibrations in a characteristic pattern are repeated while the intervals between the vibrations in this pattern gradually shorten.

As described above, in accordance with the reproduction time of the vibration waveform data, the magnification parameter, the pitch information, and the reproduction speed information are changed, whereby it is possible to generate vibrations in various patterns based on the same vibration waveform data.

### Details of Vibration Control Process

Next, the details of a vibration control process are described. First, data used in the vibration control process is described.

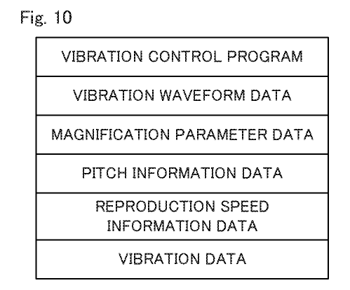

FIG. 10 is a diagram showing examples of various pieces of data stored in the game system 1. As shown in FIG. 10, the game system 1 stores a vibration control program, vibration waveform data, magnification parameter data, pitch information data, reproduction speed information data, and vibration data. These pieces of data are stored in the DRAM 27, the flash memory 26, or a storage medium attached to the slot 29.

The vibration control program includes instructions to execute a vibration control process described below. The vibration control program is stored in advance in the storage medium attached to the slot 29 or the flash memory 26 and is loaded into the DRAM 27 when a game is executed. The vibration control program may be included in a part of a game program.

The vibration waveform data is data indicating the waveform of a vibration and is stored in advance in the storage medium attached to the slot 29 or the flash memory 26. In the exemplary embodiment, a plurality of pieces of vibration waveform data are stored in advance. For example, the vibration waveform data is prepared with respect to each type of object as a vibration source in a game.

The magnification parameter data is data regarding the above magnification parameter for compressing the amplitude of the vibration waveform data. The magnification parameter data includes data regarding a plurality of magnification parameters. For example, the magnification parameter data may include data regarding a first magnification parameter that does not change in accordance with the reproduction time, and data regarding a second magnification parameter that changes in accordance with the reproduction time.

The pitch information data is data regarding the pitch information that changes the pitch of a vibration based on the vibration waveform data. The pitch information data includes data regarding a plurality of pieces of pitch information. For example, the pitch information data may include data regarding first pitch information that does not change in accordance with the reproduction time, and data regarding second pitch information that changes in accordance with the reproduction time.

The reproduction speed information data is data regarding the reproduction speed information that changes the reproduction speed of the vibration waveform data. The reproduction speed information data includes data regarding a plurality of piece of reproduction speed information. For example, the reproduction speed information data may include data regarding first reproduction speed information that does not change in accordance with the reproduction time, and data regarding second reproduction speed information that changes in accordance with the reproduction time.

The vibration data includes left vibration data to be transmitted to the left controller 3 and right vibration data to be transmitted to the right controller 4. Specifically, the vibration data includes 10-bit data indicating the amplitude and 10-bit data indicating the frequency. The vibration data is repeatedly transmitted from the main body apparatus 2 to the controllers at predetermined time intervals (e.g., 1/200-second intervals), whereby the vibrators of the controllers are vibrated.

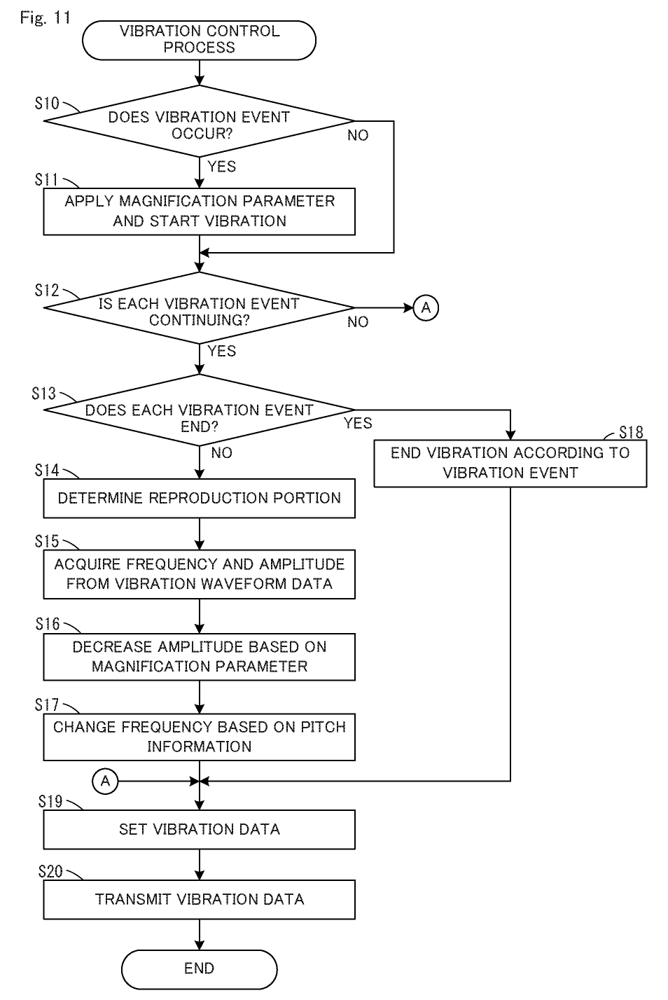

Next, a vibration control process performed by the game system 1 is described. FIG. 11 is a flow chart showing an example of the vibration control process. The vibration control process is repeatedly executed at predetermined time intervals (e.g., 1/200-second intervals). For example, the vibration control process is performed during the execution of game processing regarding a predetermined game.

In the exemplary embodiment, the description is given on the assumption that the processes of steps shown in FIG. 11 are executed by the processor 21 of the main body apparatus 2 executing the above vibration control program using a memory. In another exemplary embodiment, however, some of the processes of the steps may be executed by a processor (e.g., a dedicated circuit or the like) different from the processor 21. In a case where the game system 1 can communicate with another information processing apparatus, some of the processes of the steps may be executed by another information processing apparatus. The processes of all of the steps are merely illustrative. Thus, the processing order of the steps may be changed, or another process may be performed in addition to (or instead of) the processes of all of the steps, so long as similar results are obtained.

As shown in FIG. 11, first, the processor 21 determines whether or not a vibration event occurs (step S10). For example, the vibration event may be an event that occurs during the execution of the game processing. For example, the vibration event may be the state where a player object operated by a player (or a virtual camera set at a position according to the position of the player object) comes close to a first vibration source present in a virtual space. Alternatively, the vibration event may be the state where a second vibration source is generated in the virtual space. A plurality of vibration events may simultaneously start, or a plurality of vibration events may simultaneously continue. For example, if a second vibration event occurs while a first vibration event is continuing, a first vibration according to the first vibration event and a second vibration according to the second vibration event may be simultaneously performed. In this case, the vibrators may be controlled based on combined waveform data obtained by combining waveform data of the two vibrations.

If it is determined that a vibration event occurs (step S10: YES), the processor 21 applies a magnification parameter corresponding to the vibration event and starts a vibration according to the vibration event (step S11). Specifically, the processor 21 reads magnification parameter data and vibration waveform data corresponding to the vibration event, applies the magnification parameter, and starts the reproduction of the vibration waveform data. If the setting for changing pitch information or reproduction speed information is made for the vibration event, the processor 21 applies the pitch information or the reproduction speed information and starts the reproduction of the vibration waveform data.

If the process of step S11 is executed, or if the determination is NO in step S10, the processor 21 determines whether or not each vibration event is continuing (step S12). Here, the processor 21 determines whether or not the vibration event started in step S11 is continuing. For example, while the distance between the player object or the virtual camera and the first vibration source is less than or equal to a predetermined value, the first vibration event based on the first vibration source may be continued. If the time elapsed after the second vibration source is generated in the virtual space is less than a predetermined time, the second vibration event based on the second vibration source may be continued.

If the determination is YES in step S12, the processor 21 determines whether or not each vibration event ends (step 13). For example, if the distance between the player object or the virtual camera and the first vibration source exceeds the predetermined value, the processor 21 may determine that the first vibration event based on the vibration source ends. If the time elapsed after the second vibration source is generated in the virtual space exceeds the predetermined time, the processor 21 may determine that the second vibration event based on the second vibration source ends.

If each vibration event does not end (step S13: NO), the processor 21 determines a reproduction portion of the vibration waveform data (step S14). Specifically, if the setting for changing the reproduction speed information is not made, the processor 21 determines the elapsed time from the start of the reproduction of the vibration waveform data as a reproduction portion. Here, if the setting for changing the reproduction speed information is made, the processor 21 changes a reproduction portion according to the elapsed time based on the reproduction speed information. For example, if the reproduction speed information is a value indicating that the vibration waveform data is reproduced at 1.5-times speed, the processor 21 determines a value obtained by multiplying the elapsed time from the start of the reproduction by 1.5 as a reproduction portion.

Next, based on the reproduction portion determined in step S14, the processor 21 acquires the frequency and the amplitude stored in the vibration waveform data (step S15). Each of the amplitude and the frequency acquired in step S15 is data represented in 8 bits.

Next, the processor 21 decreases the amplitude acquired in step S15 based on the magnification parameter (step S16). Specifically, the processor 21 multiplies the amplitude acquired in step S15 by the magnification parameter. The magnification parameter may change in accordance with the reproduction time (the reproduction portion determined in step S14).

Next, if the setting for changing the pitch information is made, the processor changes the frequency acquired in step S15 based on the pitch information. For example, the processor 21 multiplies the frequency acquired in step S15 by a value indicated by the pitch information. The pitch information may change in accordance with the reproduction time (the reproduction portion determined in step S14).

If, on the other hand, it is determined that each vibration event ends (step S13: YES), the processor 21 ends a vibration according to the vibration event (step S18). Specifically, the processor 21 ends the reproduction of the vibration waveform data corresponding to the vibration event started in step S11.

If a plurality of vibration events are continuing, the processes of steps S12 to S18 are performed with respect to each vibration event.

If the process of step S17 is executed, or if the process of step S18 is executed, or if the determination is NO in step S12, the processor 21 sets vibration data (step S19). Here, based on the results of steps S12 to S18, the processor 21 sets left vibration data to be transmitted to the left controller 3 and sets right vibration data to be transmitted to the right controller 4. The left vibration data includes 10-bit data indicating the amplitude and 10-bit data indicating the frequency. The same applies to the right vibration data. Specifically, in step S19, the processor 21 sets the left and right vibration data including the amplitudes and the frequencies of combined waveforms obtained by combining waveforms according to each vibration event.

Next, the processor 21 transmits the vibration data set in step S19 (step S20). Specifically, the processor 21 transmits the left vibration data to the left controller 3 and transmits the right vibration data to the right controller 4. The left controller 3 controls the vibrator 36 based on the left vibration data, and the right controller 4 controls the vibrator 46 based on the right vibration data. Consequently, the left vibrator 36 and the right vibrator 46 are vibrated. This is the description of FIG. 11.

Before the amplitude and the frequency are calculated in steps S16 and S17, the amplitude and/or the frequency acquired from the vibration waveform data stored in advance may be attenuated in accordance with the situation of the game. For example, the amplitude and/or the frequency acquired in step S15 may be attenuated based on the distance between the player object or the virtual camera and the vibration source, and the processes of steps S16 and S17 may be performed on the attenuated amplitude and frequency.

As described above, in the exemplary embodiment, based on first waveform data (e.g., the first vibration waveform data in FIG. 4) recorded with a first resolution used to vibrate a vibration device and a magnification parameter for compressing the amplitude of the first waveform data, second waveform data (e.g., the waveform data in FIG. 5) that is waveform data obtained by compressing an amplitude of the first waveform data and has a second resolution higher than the first resolution is generated. Then, the generated second waveform data is output, and vibrators are controlled based on the second waveform data.

Consequently, it is possible to output a vibration signal having a waveform with a higher accuracy to a vibration device capable of vibrating in response to a waveform having a high resolution than in a case where waveform data recorded in advance as a waveform having a small amplitude is output.

In the exemplary embodiment, it is possible to change the magnification parameter in accordance with the reproduction time. Based on the first waveform data and the magnification parameter with respect to each reproduction time, the second waveform data may be generated in accordance with the lapse of time. Consequently, for example, the first waveform data is loop-reproduced while the magnification parameter is decreased in a stepwise manner in accordance with the reproduction time, whereby it is possible to generate a vibration of which the intensity weakens while the same waveform is repeated (e.g., FIG. 8).

In the exemplary embodiment, it is possible to change the pitch of the first waveform data based on the pitch information. In the exemplary embodiment, it is possible to change the reproduction speed of the first waveform data based on the reproduction speed information.

### Variations

While the exemplary embodiment has been described above, the exemplary embodiment is merely an example and may be modified as follows, for example.

For example, in the above exemplary embodiment, the first waveform data (e.g., FIG. 4) including a great amplitude is stored in advance, and when the first waveform data is reproduced, the second waveform data (e.g., FIG. 5) obtained by compressing the amplitude of the first waveform data using the magnification parameter is generated. Then, the vibrators are controlled based on the generated second waveform data. In another exemplary embodiment, for example, at the start of the game, the second waveform data may be generated based on the first waveform data and the magnification parameter stored in advance and stored, and if a vibration event occurs during the execution of the game, the vibrators may be controlled based on the stored second waveform data.

For example, although in the above exemplary embodiment, an example has been described where the above vibration control method is used in a game, the above vibration control method may be used in any information processing other than a game.

The above vibration control process may be executed not only by the game system 1, but also by any other information processing apparatus including a vibration device or connected to a vibration device so that the other information processing apparatus can communicate with the vibration device. For example, the above vibration control process may be performed by a smartphone, a tablet terminal, a personal computer, or the like. The above vibration control process may be performed by an information processing system including a plurality of apparatuses connected together via a network (e.g., a LAN, the Internet, or the like), and the steps in the above vibration control process may be dispersedly executed by the plurality of apparatuses.

The configurations of the above exemplary embodiment and its variations can be optionally combined together unless they contradict each other. Further, the above description is merely an example of the exemplary embodiment, and may be improved and modified in various manners other than the above.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable storage media having stored therein instructions that, when executed, cause one or more processors to perform operations comprising:
based on first waveform data recorded with a first resolution used to vibrate a vibration device and a magnification parameter for compressing the amplitude of the first waveform data, generating second waveform data that is waveform data obtained by compressing an amplitude of the first waveform data and has a second resolution higher than the first resolution; and
outputting the second waveform data.

2. The one or more non-transitory computer-readable storage media according to claim 1, wherein
the magnification parameter is recorded in response to a reproduction time of the first waveform data, and
the operations further comprise generating the second waveform data in accordance with a lapse of time based on the first waveform data and the magnification parameter with respect to each reproduction time.

3. The one or more non-transitory computer-readable storage media according to claim 1, wherein
pitch information for adjusting a pitch of the first waveform data is further recorded in response to a reproduction time of the first waveform data, and
the operations further comprise generating the second waveform data in accordance with a lapse of time based on waveform data obtained by changing the first waveform data based on the pitch information with respect to each reproduction time.

4. The one or more non-transitory computer-readable storage media according to claim 1, wherein
reproduction speed information is further recorded in response to a reproduction time of the first waveform data, and
the operations further comprise generating the second waveform data in accordance with a lapse of time by changing a reproduction portion of the first waveform data based on the reproduction speed information with respect to each reproduction time.

5. A computer-implemented method comprising:
based on first waveform data recorded with a first resolution used to vibrate a vibration device and a magnification parameter for compressing the amplitude of the first waveform data, generating second waveform data that is waveform data obtained by compressing an amplitude of the first waveform data and has a second resolution higher than the first resolution; and
outputting the second waveform data.

6. The computer-implemented method according to claim 5, wherein
the magnification parameter is recorded in response to a reproduction time of the first waveform data, and
the computer-implemented method further comprises generating the second waveform data in accordance with a lapse of time based on the first waveform data and the magnification parameter with respect to each reproduction time.

7. The computer-implemented method according to claim 5, wherein
pitch information for adjusting a pitch of the first waveform data is further recorded in response to a reproduction time of the first waveform data, and
the computer-implemented method further comprises generating the second waveform data in accordance with a lapse of time based on waveform data obtained by changing the first waveform data based on the pitch information with respect to each reproduction time.

8. The computer-implemented method according to claim 5, wherein
reproduction speed information is further recorded in response to a reproduction time of the first waveform data, and
the computer-implemented method further comprises generating the second waveform data in accordance with a lapse of time by changing a reproduction portion of the first waveform data based on the reproduction speed information with respect to each reproduction time.

9. An information processing system comprising:
one or more processors; and
one or more non-transitory computer-readable media storing instructions that, when executed, cause the one or more processors to perform operations comprising:
based on first waveform data recorded with a first resolution used to vibrate a vibration device and a magnification parameter for compressing the amplitude of the first waveform data, generating second waveform data that is waveform data obtained by compressing an amplitude of the first waveform data and has a second resolution higher than the first resolution; and
outputting the second waveform data.

10. The information processing system according to claim 9, wherein
the magnification parameter is recorded in response to a reproduction time of the first waveform data, and
the operations further comprise generating the second waveform data in accordance with a lapse of time based on the first waveform data and the magnification parameter with respect to each reproduction time.

11. The information processing system according to claim 9, wherein
pitch information for adjusting a pitch of the first waveform data is further recorded in response to a reproduction time of the first waveform data, and
the operations further comprise generating the second waveform data in accordance with a lapse of time based on waveform data obtained by changing the first waveform data based on the pitch information with respect to each reproduction time.

12. The information processing system according to claim 9, wherein
reproduction speed information is further recorded in response to a reproduction time of the first waveform data, and
the operations further comprise generating the second waveform data in accordance with a lapse of time by changing a reproduction portion of the first waveform data based on the reproduction speed information with respect to each reproduction time.
